(19) United States
(12) Patent Application Publication
(10) Pub. No.: US 2015/0242798 A1
(43) Pub. Date: Aug. 27, 2015

(54) METHODS AND SYSTEMS FOR CREATING A SIMULATOR FOR A CROWDSOURCING PLATFORM

(71) Applicant: Xerox Corporation, Norwalk, CT (US)

(72) Inventors: Guangyu Zou, Webster, NY (US); Marina L. Tharayil, Rochester, NY (US); Alvaro E. Gil, Rochester, NY (US); Deepthi Chandra, Cochin (IN); Laura Elisa Celis, Bangalore (IN)

(73) Assignee: Xerox Corporation, Norwalk, CT (US)

(21) Appl. No.: 14/190,205

(22) Filed: Feb. 26, 2014

(51) Int. Cl. G06Q 10/06

(52) U.S. Cl. CPC G06Q 10/063114

(57) ABSTRACT

The disclosed embodiments illustrate methods and systems for creating a simulator for a crowdsourcing platform. The method includes generating a plurality of rules indicative of at least one of a behavior or an interaction, of one or more entities associated with the crowdsourcing platform, based on one or more parameters associated with each of the one or more entities. Thereafter, a first level of service of the crowdsourcing platform is estimated based on the generated plurality of rules. Further, the plurality of rules are modified based on the first level of service and an observed level of service of the crowdsourcing platform. The plurality of rules are modified such that a second level of service of the crowdsourcing platform, estimated based on the modified plurality of rules, approaches the observed level of service of the crowdsourcing platform. The modified plurality of rules corresponds to the simulator for the crowdsourcing platform.

### TECHNICAL FIELD

The presently disclosed embodiments are related, in general, to crowdsourcing. More particularly, the presently disclosed embodiments are related to methods and systems for creating a simulator for a crowdsourcing platform.

### BACKGROUND

With the advancements in communication technology and the widespread penetration of the internet, various enterprises and individuals (hereinafter collectively referred to as requestors) are seeking collaborative solutions to their tasks from loosely bound groups of workers through the internet. The requestors may post the tasks on various online portals (hereinafter referred to as crowdsourcing platforms), which act as mediators between the requestors and the workers. The workers, in turn may fetch the tasks from the crowdsourcing platforms and thereafter post responses for the tasks on the crowdsourcing platforms. The crowdsourcing platforms, in turn may forward these responses to the requestors for evaluation.

Usually, the crowdsourcing platforms are unpredictable with respect to various factors such as availability of the workers, accuracy of the workers in attempting the tasks, and so on. Hence, to leverage maximum benefits from crowdsourcing, there is a need for a solution that facilitates simulation of the crowdsourcing platforms.

### SUMMARY

According to embodiments illustrated herein, there is provided a method for creating a simulator for a crowdsourcing platform. The method comprises generating, by one or more processors, a plurality of rules indicative of at least one of a behavior or an interaction, of one or more entities associated with the crowdsourcing platform, based on one or more parameters associated with each of the one or more entities. Thereafter, a first level of service of the crowdsourcing platform is estimated by the one or more processors based on the generated plurality of rules. Further, the plurality of rules are modified by the one or more processors based on the first level of service and an observed level of service of the crowdsourcing platform, wherein the observed level of service is determined from the crowdsourcing platform. The modified plurality of rules corresponds to the simulator for the crowdsourcing platform.

According to embodiments illustrated herein, there is provided a method for creating a simulator for a business environment. The method comprises generating, by one or more processors, a plurality of rules indicative of at least one of a behavior or an interaction, of one or more entities associated with the business environment, based on one or more parameters associated with each of the one or more entities. Thereafter, a first level of service of the business environment is estimated by the one or more processors based on the generated plurality of rules. Further, the plurality of rules are modified by the one or more processors based on the first level of service and an observed level of service of the business environment, wherein the observed level of service is determined from the business environment. The modified plurality of rules corresponds to the simulator for the business environment.

According to embodiments illustrated herein, there is provided a system for creating a simulator for a crowdsourcing platform. The system includes one or more processors that are operable to generate a plurality of rules indicative of at least one of a behavior or an interaction, of one or more entities associated with the crowdsourcing platform, based on one or more parameters associated with each of the one or more entities. Thereafter, a first level of service of the crowdsourcing platform is estimated based on the generated plurality of rules. Further, the plurality of rules is modified based on the first level of service and an observed level of service of the crowdsourcing platform, wherein the observed level of service is determined from the crowdsourcing platform. The modified plurality of rules corresponds to the simulator for the business environment.

According to embodiments illustrated herein, there is provided a computer program product for use with a computing device. The computer program product comprises a non-transitory computer readable medium, the non-transitory computer readable medium stores a computer program code for creating a simulator for a crowdsourcing platform. The computer readable program code is executable by one or more processors in the computing device to generate a plurality of rules indicative of at least one of a behavior or an interaction, of one or more entities associated with the crowdsourcing platform, based on one or more parameters associated with each of the one or more entities. The one or more entities correspond to requestors, tasks, and workers. Further, a crowdsourcing environment is associated with the crowdsourcing platform. Thereafter, a first level of service of the crowdsourcing platform is estimated based on the generated plurality of rules. A level of service of the crowdsourcing platform comprises at least one of a task completion time, a task completion cost, a task accuracy score, a task completion rate, or a number of tasks completed in a period. Further, the plurality of rules is modified based on the first level of service and an observed level of service of the crowdsourcing platform, wherein the observed level of service is determined from the crowdsourcing platform. The plurality of rules are modified such that a second level of service of the crowdsourcing platform, estimated based on the modified plurality of rules, approaches the observed level of service of the crowdsourcing platform. The modified plurality of rules corresponds to the simulator for the business environment.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment in which various embodiments can be implemented;

FIG. 2 is a block diagram that illustrates a system for creating a simulator for simulating a crowdsourcing platform, in accordance with at least one embodiment;

FIG. 3 is a flowchart that illustrates a method for creating a simulator for simulating a crowdsourcing platform, in accordance with at least one embodiment;

FIGS. 4A and 4B illustrate an example distribution for requestors and workers respectively, in accordance with at least one embodiment;

FIG. 5 is a flowchart that illustrates a method for modifying a plurality of rules, in accordance with at least one embodiment; and

FIG. 6 is a block diagram that illustrates an example scenario of tuning a crowdsourcing simulator with respect to an observed level of service of a crowdsourcing platform, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example”, and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

### DEFINITIONS

The following terms shall have, for the purposes of this application, the meanings set forth below.

A “task” refers to a piece of work, an activity, an action, a job, an instruction, or an assignment to be performed. Tasks may necessitate the involvement of one or more workers. Examples of tasks include, but are not limited to, digitizing a document, generating a report, evaluating a document, conducting a survey, writing a code, extracting data, translating text, and the like.

“Crowdsourcing” refers to distributing tasks by soliciting the participation of loosely defined groups of individual crowdworkers. A group of crowdworkers may include, for example, individuals responding to a solicitation posted on a certain website such as, but not limited to, Amazon Mechanical Turk, Crowd Flower, or Mobile Works.

A “crowdsourcing platform” refers to a business application, wherein a broad, loosely defined external group of people, communities, or organizations provide solutions as outputs for any specific business processes received by the application as inputs. In an embodiment, the business application may be hosted online on a web portal (e.g., crowdsourcing platform servers). Examples of the crowdsourcing platforms include, but are not limited to, Amazon Mechanical Turk, Crowd Flower, or Mobile Works.

A “crowdworker” refers to a workforce/worker(s) that may perform one or more tasks that generate data that contributes to a defined result. According to the present disclosure, the crowdworker(s) includes, but is not limited to, a satellite center employee, a rural business process outsourcing (BPO) firm employee, a home-based employee, or an internet-based employee. Hereinafter, the terms “crowdworker”, “worker”, “remote worker”, “crowdsourced workforce”, and “crowd” may be used interchangeably.

“One or more entities associated with a crowdsourcing platform” refer collectively to the requestors, the tasks, and the workers, which are associated with the crowdsourcing platform.

A “crowdsourcing environment associated with a crowdsourcing platform” refers to a framework of rules that may govern an interaction between the one or more entities (i.e., the requestors, the tasks, and the workers) associated with the crowdsourcing platform. In an embodiment, one or more aspects associated with the crowdsourcing environment may include, but are not limited to, a task submission by the requestors, a task allocation to the workers, a degree of association among the workers, a degree of association between the workers and the requestors, a task performance by the workers, a task evaluation by the requester, and a remuneration of the workers. Further, in an embodiment, a type of the crowdsourcing environment is deterministic of the interaction between the requestors, the tasks, and the workers.

A “plurality of rules” refers to a set of conditions indicative of at least one of a behavior or an interaction, of the one or more entities (i.e., the requestors, the tasks, and the workers) with each other. In an embodiment, the plurality of rules is generated based on at least one or more parameters associated with each of the one or more entities. Further, in an embodiment, the plurality of rules may also be generated based on the one or more aspects associated with the crowdsourcing environment.

A “level of service” corresponds to at least a performance measure of processing of one or more tasks by the crowdsourcing platform. In an embodiment, the level of service of the crowdsourcing platform comprises at least one of a task completion time, a task completion cost, a task accuracy score, a task completion rate, or a number of tasks completed in a period.

A “task completion cost” refers to an expense incurred by the requestors to get the tasks completed through crowdsourcing. In an embodiment, the task completion cost may include a remuneration payable by the requestors to the workers for working on the tasks. In an embodiment, examples of the remuneration may include, but are not limited to, a monetary compensation, lottery tickets, gift items, shopping vouchers, and discount coupons. In another embodiment, remuneration may further correspond to strengthening of the relationship between the worker and the requestor. For example, the requestor may provide the worker with an access to more tasks so that the worker can gain more. In addition, the crowdsourcing platform may improve a reputation score associated with the worker. In an embodiment, the worker with a higher reputation score may receive a higher remuneration. A person skilled in the art would understand that combination of any of the above-mentioned means of remuneration could be used and the task completion cost for the requestors may be inclusive of such remunerations receivable by the corresponding workers.

A “task accuracy score” refers to a quality of the responses received from the worker for the one or more tasks. In an embodiment, the task accuracy score of the worker is higher if the responses received from the worker are closer to the correct answers of the one or more tasks.

A “task completion rate” refers to a measure of a number of tasks completed per unit time by the workers.

A “crowd-labor platform” refers to a crowdsourcing platform in which the workers solve the one or more tasks independently. In an embodiment, one or more workers may work on one or more tasks posted by one or more requestors on the crowd-labor platform for remuneration. Examples of crowd-labor platforms include, but are not limited to, Amazon Mechanical Turk, Crowd Flower, Mobile Workers, etc.

A “crowd-funding platform” refers to a crowdsourcing platform for funding community projects through donations/contributions received from the public at large. In an embodiment, one or more organizations (such as NGOs, Government Institutions, Universities, individuals, etc.) may solicit funds/donations from the public for various social/community/research projects through the crowd-funding platform. Examples of crowd-funding platforms include, but are not limited to, C-Crowd, Crowd Cube, Crowd Rise, etc.

A “creative-design platform” refers to a crowdsourcing platform for collecting opinions, and judgments from a target audience to design new products or improve designs of existing products. The designs on which opinions are sought from the target audience may include graphical designs, architectural designs, writing and illustrations, etc. Examples of creative-design platforms include, but are not limited to, 99designs, Design Crowd, Crowd Spring, etc.

An “open-innovation platform” refers to a crowdsourcing platform for collaborative generation of knowledge from the public at large to provide a richer knowledge base for the public. Such platforms leverage the collective intelligence of the public to find new solutions to various known problems/situations. Examples of open-innovation platforms include, but are not limited to, Innocentive, Innovation Challenge, Netflix, etc.

A “business environment” refers to a set of predetermined business processes and workflows that govern the functioning of various organizations such as business houses, enterprises, government organizations, etc. In an embodiment, the business environment may correspond to a set of rules or predefined business practices that are followed in regular course of operation by these various organizations. Further, in an embodiment, the various organizations may outsource some of their business processes and workflows to external organizations and/or individuals. Examples of such business environments include, but are not limited to, a business process outsourcing platform, a legal process outsourcing platform, a knowledge process outsourcing platform, a home-sourcing platform, and a crowdsourcing platform. Further, a crowdsourcing platform may be of various types such as, but not limited to, a crowd-labor platform, a crowd-funding platform, a creative-design platform, and an open-innovation platform.

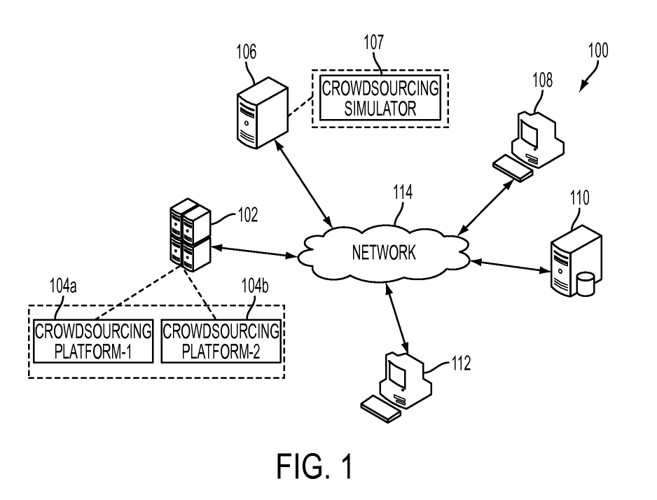

FIG. 1 is a block diagram of a system environment 100, in which various embodiments can be implemented. The system environment 100 includes a crowdsourcing platform server 102, an application server 106, a requestor-computing device 108, a database server 110, a worker-computing device 112, and a network 114.

In an embodiment, the crowdsourcing platform server 102 is operable to host one or more crowdsourcing platforms (e.g., a crowdsourcing platform-1 104a and a crowdsourcing platform-2 104b). One or more workers are registered with the one or more crowdsourcing platforms. In an embodiment, the crowdsourcing platform may receive one or more tasks from one or more requestors. Further, the crowdsourcing platform (such as the crowdsourcing platform-1 104a or the crowdsourcing platform-2 104b) may offer the one or more tasks to the one or more workers. In an embodiment, the crowdsourcing platform presents a user interface to the one or more workers through a web-based interface or a client application. The one or more workers may access the one or more tasks through the web-based interface or the client application. Further, the one or more workers may submit a response to the crowdsourcing platform through the user interface. Thereafter, the crowdsourcing platform may forward the responses received for the one or more tasks to the one or more requestors.

In an embodiment, the crowdsourcing platform server 102 may monitor the crowdsourcing platform (e.g., the crowdsourcing platform-1 104a) to determine statistical data pertaining to the workers, the tasks, the requestors, and a crowdsourcing environment, associated with the crowdsourcing platform (i.e., 104a) over a period of time. Further, in an embodiment, the crowdsourcing platform 102 may determine an observed level of service of the crowdsourcing platform (e.g., 104a). In an embodiment, a level of service of the crowdsourcing platform comprises at least one of a task completion time, a task completion cost, a task accuracy score, a task completion rate, or a number of tasks completed in a period. In an alternate embodiment, the crowdsourcing platform (e.g., 104a) may determine the statistical data and the observed level of service. In such a scenario, the crowdsourcing platform (i.e., 104a) may periodically provide the crowdsourcing platform server 102 with such information. In an embodiment, the crowdsourcing platform 102 may send the statistical data and the observed level of service, to the application server 106 in response to a request from the application server 106 for such information.

A person skilled in the art would understand that though FIG. 1 illustrates the crowdsourcing platform server 102 as hosting only two crowdsourcing platforms (i.e., the crowdsourcing platform-1 104a and the crowdsourcing platform-2 104b), the crowdsourcing platform server 102 may host more than two crowdsourcing platforms without departing from the spirit of the disclosure.

In an embodiment, the crowdsourcing platform server 102 may be realized through an application server such as, but not limited to, a Java application server, a .NET framework, and a Base4 application server.

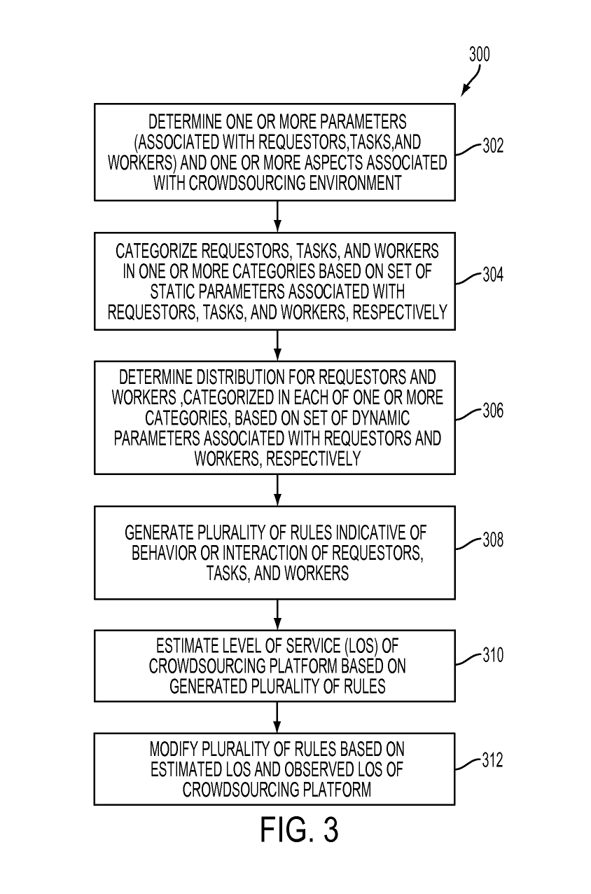

In an embodiment, the application server 106 receives the statistical data from the crowdsourcing platform server 102. Thereafter, based on the statistical data, the application server 106 may determine one or more parameters associated with the requestors, the tasks, and the workers, which are associated with the crowdsourcing platform (e.g., 104a). In addition, the application server 106 may also determine one or more aspects associated with the crowdsourcing environment based on the statistical data. In an embodiment, the one or more parameters associated the requestors, the tasks, and the workers may include at least one of a set of static parameters or a set of dynamic parameters. The determination of the one or more parameters (including the set of static parameters and the set of dynamic parameters), and the one or more aspects associated with the crowdsourcing environment has been explained further in conjunction with FIG. 3. Further, in an embodiment, the application server 106 may categorize the requestors, the tasks, and the workers into one or more categories based on the set of static parameters associated with the requestors, the tasks, and the workers, respectively. In an embodiment, the application server 106 may determine a distribution for the set of dynamic parameters associated with the requestors and the workers, belonging to each of the one or more categories. In an embodiment, the application server 106 may utilize one or more curve fitting techniques to determine the distribution for the requestors and the workers, categorized in each of the one or more categories. The categorization of the requestors, the tasks, and the workers in the one or more categories, and the determination of the distribution for the requestors and the workers categorized within each of the one or more categories has been further explained in conjunction with FIG. 3.

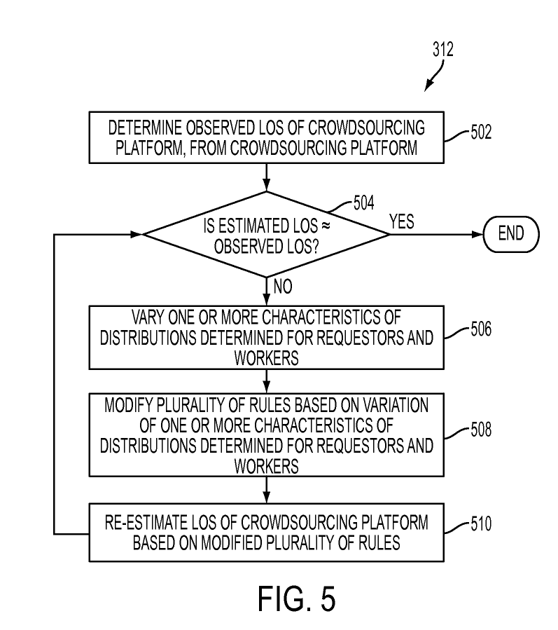

Further, in an embodiment, the application server 106 may generate a plurality of rules indicative of at least one of a behavior or an interaction of the requestors, the tasks, and the workers based on the distribution determined for the requestors and the workers categorized within each of the one or more categories. In an embodiment, the plurality of rules may also be generated based on the categorization of the tasks into the one or more categories. In addition, in an embodiment, the plurality of rules may be generated based on the one or more aspects associated with the crowdsourcing environment. In an embodiment, a type of the crowdsourcing environment may be deterministic of the interaction between the requestors, the tasks, and the workers, which are associated with the crowdsourcing platform (e.g., 104a). Further, in an embodiment, the application server 106 may estimate a first level of service of the crowdsourcing platform based on the generated plurality of rules. Post the estimation of the first level of service, the application server 106 may modify the plurality of rules based on the first level of service and the observed level of service, which is received from the crowdsourcing platform server 102. In an embodiment, the modified rules may correspond to a crowdsourcing simulator 107. The creation of the crowdsourcing simulator 107 for simulating the crowdsourcing platform has been further explained in conjunction to FIG. 3. Further, the method of modification of the plurality of rules has been explained in conjunction to FIG. 5.

Some examples of the application server 106 may include, but are not limited to, a Java application server, a .NET framework, and a Base4 application server.

A person with ordinary skill in the art would understand that the scope of the disclosure is not limited to illustrating the application server 106 as a separate entity. In an embodiment, the functionality of the application server 106 may be implementable on/integrated with the crowdsourcing platform server 102.

In an embodiment, the requestor-computing device 108 is a computing device used by the requestor to send the one or more tasks to the crowdsourcing platform (e.g., 104a). In an embodiment, the requestor may send the one or more tasks to the application server 106. The application server 106 may utilize the crowdsourcing simulator 107 to estimate a level of service that the requestor may get if the requestor posts the tasks on the crowdsourcing platform (e.g., 104a). Thereafter, the application server 106 may forward the one or more tasks to the crowdsourcing platform (e.g., 104a). Alternatively, the requestor may directly send the one or more tasks to the crowdsourcing platform (e.g., 104a). Examples of the requestor-computing device 108 include, but are not limited to, a personal computer, a laptop, a personal digital assistant (PDA), a mobile device, a tablet, or any other computing device.

In an embodiment, the database server 110 is operable to store the statistical data, the one or more parameters (associated with the requestors, the tasks, and the workers), the one or more aspects associated with the crowdsourcing environment, and the distributions determined for the requestors and the workers categorized within each of the one or more categories. In addition, the database server 110 may also store the plurality of rules generated by the application server 106. In an embodiment, the database server 110 may receive a query from the crowdsourcing platform server 102 and/or the application server 106 to extract at least one of the statistical data, the one or more parameters, the one or more aspects associated with the crowdsourcing environment, the determined distributions, or the plurality of rules from the database server 110. The database server 110 may be realized through various technologies such as, but not limited to, Microsoft® SQL server, Oracle, and My SQL. In an embodiment, the crowdsourcing platform server 102 and/or the application server 106 may connect to the database server 110 using one or more protocols such as, but not limited to, Open Database Connectivity (ODBC) protocol and Java Database Connectivity (JDBC) protocol.

A person with ordinary skill in the art would understand that the scope of the disclosure is not limited to the database server 110 as a separate entity. In an embodiment, the functionalities of the database server 110 can be integrated into the crowdsourcing platform server 102 and/or the application server 106.

In an embodiment, the worker-computing device 112 is a computing device used by the worker. The worker-computing device 112 is operable to present the user interface (received from the crowdsourcing platform) to the worker. The worker is presented with the one or more tasks received from the crowdsourcing platform through the user interface. Thereafter, the worker may submit the responses for the one or more tasks through the user interface to the crowdsourcing platform. Examples of the worker-computing device 112 include, but are not limited to, a personal computer, a laptop, a personal digital assistant (PDA), a mobile device, a tablet, or any other computing device.

The network 114 corresponds to a medium through which content and messages flow between various devices of the system environment 100 (e.g., the crowdsourcing platform server 102, the application server 106, the requestor-computing device 108, the database server 110, and the worker-computing device 112). Examples of the network 114 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 114 in accordance with various wired and wireless communication protocols such as Transmission Control Protocol and Internet Protocol (TCP/IP), User Datagram Protocol (UDP), and 2G, 3G, or 4G communication protocols.

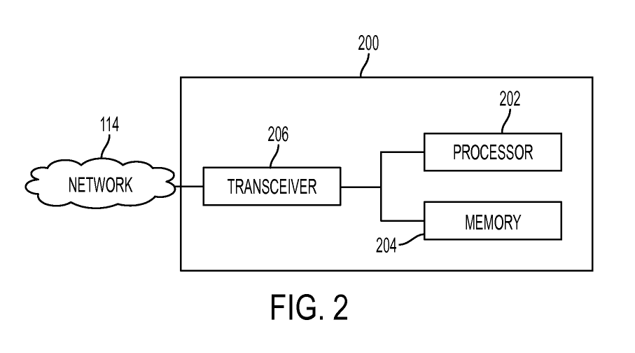

FIG. 2 is a block diagram that illustrates a system 200 for creating the crowdsourcing simulator 107 for simulating the crowdsourcing platform (e.g., 104a), in accordance with at least one embodiment. In an embodiment, the system 200 may correspond to the crowdsourcing platform server 102, the application server 106, or the requestor-computing device 108. For the purpose of ongoing description, the system 200 is considered as the application server 106. However, the scope of the disclosure should not be limited to the system 200 as the application server 106. The system 200 can also be realized as the crowdsourcing platform server 102 or the requestor-computing device 108.

The system 200 includes a processor 202, a memory 204, and a transceiver 206. The processor 202 is coupled to the memory 204 and the transceiver 206. The transceiver 206 is connected to the network 114.

The processor 202 includes suitable logic, circuitry, and/or interfaces that are operable to execute one or more instructions stored in the memory 204 to perform predetermined operations. The processor 202 may be implemented using one or more processor technologies known in the art. Examples of the processor 202 include, but are not limited to, an x86 processor, an ARM processor, a Reduced Instruction Set Computing (RISC) processor, an Application-Specific Integrated Circuit (ASIC) processor, a Complex Instruction Set Computing (CISC) processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person with ordinary skills in the art that the one or more instructions stored in the memory 204 enable the hardware of the system 200 to perform the predetermined operations.

The transceiver 206 transmits and receives messages and data to/from various components of the system environment 100 (e.g., the crowdsourcing platform server 102, the requestor-computing device 108, the database server 110, and the worker-computing device 112) over the network 114. Examples of the transceiver 206 may include, but are not limited to, an antenna, an Ethernet port, a USB port, or any other port that can be configured to receive and transmit data. The transceiver 206 transmits and receives data/messages in accordance with the various communication protocols, such as, TCP/IP, UDP, and 2G, 3G, or 4G communication protocols.

The operation of the system 200 for creating the crowdsourcing simulator 107 for simulating the crowdsourcing platform has been described in conjunction with FIG. 3.

FIG. 3 is a flowchart 300 that illustrates a method for creating the crowdsourcing simulator 107 for the crowdsourcing platform (e.g., 104a), in accordance with at least one embodiment. The flowchart 300 is described in conjunction with FIG. 1 and FIG. 2.

At step 302, the one or more parameters (associated with the requestors, the tasks, and the workers) and the one or more aspects associated with the crowdsourcing environment are determined. In an embodiment, the processor 202 is configured to determine the one or more parameters and the one or more aspects. Hereinafter, the requestors, the tasks, and the workers are collectively referred as one or more entities associated with the crowdsourcing platform. In an embodiment, the processor 202 may determine the one or more parameters (associated with the one or more entities) and the one or more aspects (associated with the crowdsourcing environment) based on the statistical data. In an embodiment, the statistical data corresponds to a historical data associated with each of the one or more entities and the crowdsourcing environment. An example of the statistical data is illustrated in the following table:

TABLE 1
An example of the statistical data received from the
crowdsourcing platform server 102.

| | Tasks submitted | Tasks completed | |
|---|---|---|---|
| Time of day | by requestors | by workers | Pending tasks |
| 9 am-1 pm | 1000 | 750 | 300 |
| 1 pm-5 pm | 1250 | 950 | 600 |
| 5 pm-9 pm | 750 | 800 | 550 |
| 9 pm-1 am | 150 | 300 | 400 |
| 1 am-5 am | 100 | 350 | 150 |
| 5 am-9 am | 250 | 300 | 100 |

Referring to Table 1, the statistical data includes data pertaining to task submission by the requestors, task completion by the workers, and pending tasks on the crowdsourcing platform. Each row of Table 1 illustrates an average number of tasks submitted by the requestors, an average number of tasks completed by the workers, and an average number of pending tasks on the crowdsourcing platform during a time interval in a day. For instance, during 9 am to 1 pm, the requestors submit 1000 tasks on an average, while the workers complete 750 tasks on an average. The number of pending tasks on the crowdsourcing platform during this time interval is 300, considering an average backlog of 50 tasks carried forward from the previous day. Similarly, during 1 pm to 5 pm, the average number of tasks submitted by the requestors is 1250, the average number of tasks completed by the workers is 950, and the average number of pending tasks is 600, and so on.

The One or More Parameters Associated with the Requestors

In an embodiment, the one or more parameters associated with the requestor may include a set of static parameters (such as, but not limited to, a time zone of the requestor and a requestor-type of the requestor) and a set of dynamic parameters (such as, but not limited to, a task submission rate of the requestor, an expected task accuracy of the requestor, an expected service time of the requestor, and a remuneration offered per task by the requestor).

In an embodiment, the time zone of the requestor may be determined based on a location where the requestor resides. For example, information pertaining to the location of the requestors registered with the crowdsourcing platform may be determined from the crowdsourcing platform. Thereafter, the time zones of the requestors may be determined from the information pertaining to the locations.

The requestor-type of the requestors may include, but are not limited to, an enterprise requestor, a university/academic institution, a government organization, or an individual requestor. In an embodiment, the requestor may provide the crowdsourcing platform with their credentials such as, but not limited to, an organization in which the requestor is employed, profession details of the requestor, the requestor's designation/role in the organization, and so on. Further, in an embodiment, the requestor-type of the requestors may be determined based on such credentials provided by the requestors to the crowdsourcing platform. A person skilled in the art would appreciate that such credentials may be privacy protected and may not be readily available from the crowdsourcing platform. Hence, in an embodiment, the crowdsourcing platform may determine the requestor-type of each requestor and provide aggregate level information pertaining to the requestor-types of the requestors within the statistical data.

In an embodiment, the statistical data received from the crowdsourcing platform server 102 may also be used to determine parameters such as the task submission rate, the expected task accuracy of the requestor, the expected service time of the requestor, and the remuneration offered per task by the requestor. In an embodiment, while submitting the tasks to the crowdsourcing platform, the requestor may provide the crowdsourcing platform with metadata information related to the tasks such as, but not limited to, task accuracy requirements, worker qualification requirements, a task completion deadline, a remuneration amount offered for the tasks, etc. Further, in an embodiment, the crowdsourcing platform may aggregate such information and may provide this aggregated information within the statistical data. In an embodiment, the processor 202 may determine the aforementioned parameters (i.e., the task submission rate, the expected task accuracy of the requestor, the expected service time of the requestor, and the remuneration offered per task by the requestor) from such aggregated information present within the statistical data.

The One or More Parameters Associated with the Tasks

In an embodiment, the one or more parameters associated with the task may include a set of static parameters (such as, but not limited to, a task type and a task qualification, a task submission time, a task expiration time, and a task remuneration).

As discussed, while submitting a task to the crowdsourcing platform, in an embodiment, the requestor may provide the crowdsourcing platform with the metadata information related to the tasks such as, but not limited to, accuracy requirements of the task, worker qualification requirements, a completion deadline associated with the task, a remuneration amount offered for the task, etc. The requestor may also provide information pertaining to the task type associated with the submitted task. Further, in an embodiment, the crowdsourcing platform may determine the submission time of the task as the time when the crowdsourcing platform receives the task from the requestor. In an embodiment, the crowdsourcing platform may determine the expiration time of the task based on the task submission time and the completion deadline associated with the task. In addition, in an embodiment, the crowdsourcing platform may determine the task type, the task qualification (which may include the accuracy requirements of the task and the worker qualification requirements), and the task remuneration, based on the metadata information related to the task received from the requestor.

The One or More Parameters Associated with the Workers

In an embodiment, the one or more parameters associated with the worker may include a set of static parameters (such as, but not limited to, an age of a worker, a gender of the worker, a time zone in which the worker is located, and a qualification of the worker) and a set of dynamic parameters (such as, but not limited to, working hours of the worker, an accuracy score of the worker, a capability of the worker, a service time of the worker, and an expected remuneration of the worker).

In an embodiment, the workers may provide their credentials with the crowdsourcing platform while registering with the crowdsourcing platform. The credentials associated with the workers may include, but are not limited to, personal details (such as name, age, gender, address/location, etc.), educational/professional details (such as educational qualifications, professional field, an organization in which the worker is employed, designation/role in the organization, etc.), and so on. Further, the workers may provide the crowdsourcing platforms with various preferences such as, but not limited to, expected remuneration per task, mode of accepting remuneration (e.g., coupons, tickets, gifts, discounts, cash, bank deposit, etc.). In an embodiment, the crowdsourcing platform may monitor the working hours of the workers as the workers work on the tasks available on the crowdsourcing platform. Further, in an embodiment, the crowdsourcing platforms may determine an accuracy score for each worker based on an accuracy associated with the responses (e.g., a ratio of number of correct responses to total number of responses provided) provided by the worker. In an embodiment, the crowdsourcing platform may provide aggregate level information pertaining to the age groups, the gender, the time zone of the workers, and the qualifications of the workers within the statistical data. In addition, in an embodiment, the crowdsourcing platform may collate statistics related to the workers based on the worker preferences, monitored working hours of the workers, and the accuracy scores of the workers. The crowdsourcing platform may also provide such statistics related to the workers within the statistical data.

The One or More Aspects Associated with the Crowdsourcing Environment

In an embodiment, the crowdsourcing environment is deterministic of one or more rules governing interaction between the requestors, the tasks, and the workers. For example, the crowdsourcing environment may govern various aspects such as, but not limited to, a task submission by the requestors, a task allocation to the workers, a degree of association among the workers, a degree of association between the workers and the requestors, a task performance by the workers, a task evaluation by the requester, and a remuneration of the workers. The following table illustrates the one or more aspects associated with the crowdsourcing environment:

TABLE 2
An example of the one or more aspects associated with
the crowdsourcing environment.

| Aspect of interaction | Examples |
|---|---|
| Task submission by | Minimum batch size, |
| the requestors | Maximum batch size, |
| | Minimum task expiry period, |
| | Maximum task expiry period, |
| | Subscription fees per batch of task. |
| Task allocation to the | Minimum tasks per allocation (per worker), |
| workers | Maximum tasks per allocation (per worker). |
| Degree of association | Type of collaboration between workers, |
| among the workers | Minimum collaborative workers pertask, |
| | Maximum collaborative workers pertask. |
| Degree of association | Type of requestor-worker interactions, |
| between the workers | Minimum requestor-worker interactions per task, |
| and the requestors | Maximum requestor-worker interactions per task. |
| Task performance by | Type of crowdsourcing platform, |
| the workers | Minimum workers per task, |
| | Maximum workers per task. |
| Task evaluation by the | Type of task validation, |
| requester | Minimum responses per task, |
| | Maximum responses per task. |
| Remuneration of the | Modes of remuneration to workers, |
| workers | Minimum remuneration per task, |
| | Maximum remuneration per task. |

In an embodiment, the one or more aspects associated with the crowdsourcing environment are utilized by the processor 202 to generate the one or more rules. The generation of the one or more rules has been described later.

A person skilled in the art would understand that the scope of the disclosure should not be limited to the examples of the one or more parameters (associated with the requestors, the tasks, and the workers) and the one or more aspects associated with the crowdsourcing environment, as illustrated above. Such examples are for illustrative purpose and the disclosure may be implemented using various other parameters (associated with the requestors, the tasks, and the workers) and various other aspects associated with the crowdsourcing environment.

At step 304, the requestors, the tasks, and the workers are categorized. In an embodiment, the processor 202 is configured to categorize the requestors, the tasks, and the workers in one or more respective categories based on the set of static parameters associated with the requestors, the tasks, and the workers, respectively.

### Categorization of the Requestors

As discussed, the set of static parameters associated with the requestor may include the time zone of the requestor and the requestor-type of the requestor. In an embodiment, examples of the requestor-type may include, but are not limited to, an enterprise requestor, a university/academic institution, a government organization, and an individual requestor. Thus, the requestors may be categorized into four categories based on the requestor-type. Further, the requestors may also be categorized based on their respective time zones such as, Pacific Standard Time (PST), Eastern Standard Time (EST), Greenwich Meridian Time (GMT), Indian Standard Time (IST), etc.

Categorization of the Workers

As discussed, the set of static parameters associated with the worker may include various worker demographics such as age of the worker, gender of the worker, location of the worker, qualifications of the worker, etc. The workers may be categorized based on such worker demographics. For example, worker-1 and worker-2 are from US, while worker-3 and worker-4 are from Europe. The processor 202 may categorize the workers worker-1 and worker-2 in the same category (i.e., workers belonging to US). Similarly, the workers worker-3 and worker-4 will be categorized in the same category (i.e., workers belonging to Europe). On similar terms, the workers may be categorized based on the gender and age. Further, the workers may be categorized based on the workers' qualifications (which may include educational and/or professional qualifications).

### Categorization of the Tasks

As discussed, the set of static parameters associated with the task may include the task-type, the task qualification, the task submission time, the task expiration time, and the task remuneration. Thus, the tasks may be categorized based on the task type, for instance, an image-tagging task, a form digitization task, a language translation task, an audio/video transcription task, and so on. Further, the tasks may also be categorized based on the task qualification such as required accuracy score and required qualifications of workers. In a similar manner, the tasks may be categorized into the one or more categories based on other static parameters associated with the tasks.

A person skilled in the art would understand that the scope of the disclosure should not be limited to the categorization of the requestors, the tasks, and the workers, as described above. The requestors, the tasks, and the workers may be categorized using various other parameters without departing from the spirit of the disclosure.

At step 306, the distribution is determined for the requestors and the workers categorized in each of the one or more categories. In an embodiment, the processor 202 is configured to determine the distribution for the requestors and the workers within each of the one or more categories. In an embodiment, the processor 202 may determine the distribution using one or more curve fitting techniques including, but not limited to, least square curve fitting, regression based curve fitting, Levenberg-Marquardt algorithm, or any other curve-fitting algorithms. As described in step 304, the processor 202 categorizes the requestors, the tasks, and the workers into the one or more categories, based on the set of static parameters associated with the requestors, the tasks, and the workers, respectively. In an embodiment, the processor 202 may utilize the one or more curve fitting techniques to determine the distribution for the requestors within each of the one or more categories, based on the set of dynamic parameters associated with the requestors. Similarly, the processor 202 may utilize the one or more curve fitting techniques to determine the distribution for the workers within each of the one or more categories, based on the set of dynamic parameters associated with the workers.

### Distribution for the Requestors

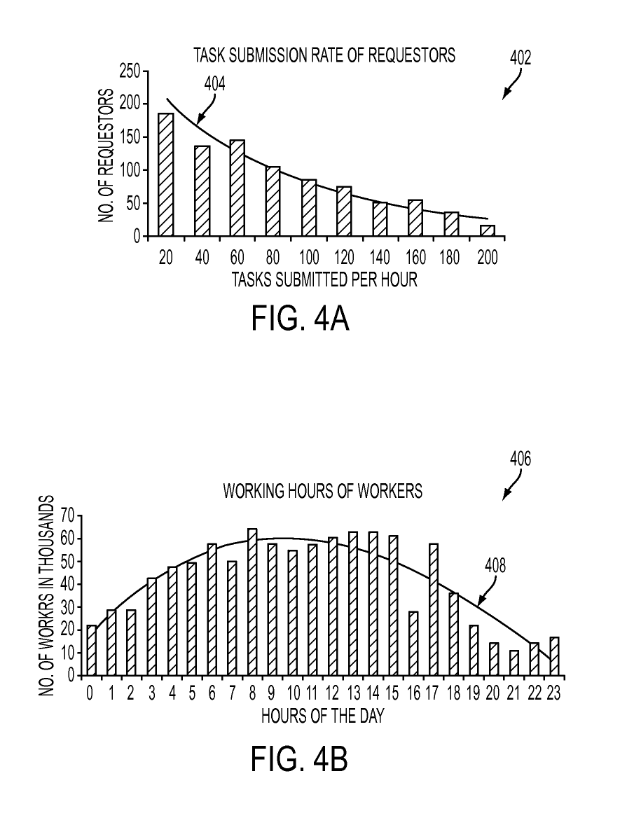

As discussed, the requestors are categorized based on the set of static parameters associated with the requestors including the location of the requestor and the requestor-type of the requestor. For requestors from a particular location, in an embodiment, the processor 202 determines a distribution pertaining to the set of dynamic parameters associated with the requestors including the task submission rate, the expected task accuracy, and the expected service time. Similarly, in an embodiment, the processor 202 determines a distribution pertaining to the set of dynamic parameters associated with requestors for the requestors that have been categorized based on the requestor-type. An example distribution for the requestor has been illustrated in the FIG. 4A.

### Distribution for the Workers

In an embodiment, for workers in each category (determined based on the set of static parameters associated with the workers), the processor 202 may determine distribution for the workers based on the set of dynamic parameters associated with the workers. For example, based on the time zones of the workers (which is a parameter in the set of static parameters), the processor 202 may categorize the workers into 3 categories such as worker category-1 (that includes workers belonging to India), worker category-2 (that includes workers belonging to South-East Asia), and worker category-3 (that includes workers belonging to the US). Thereafter, for the worker category-1, the processor 202 may determine a distribution pertaining to the set of dynamic parameters associated with the workers including the working hours, the worker capability, the service time, and the accuracy score of the workers. For instance, for the worker category-1, the processor 202 may determine a distribution D1 for the parameter “working hours” as a normal distribution. To determine the distribution D1, the processor 202 may apply the one or more curve fitting algorithms and estimate a best-fitting curve (i.e., a function) that approximates the values of this parameter (i.e., “working hours” of the workers belonging to the worker category-1) within the statistical data. In a similar manner, for the workers belonging to the worker category-1, the processor 202 may determine distributions D2, D3, and D4 for the parameters such as the worker capability, the service time, and the accuracy score of the workers, respectively. Similarly, for the workers belonging to the worker category-2 (i.e., the workers located in South East Asia), the processor 202 determines a distribution pertaining to the set of dynamic parameters associated with the workers. Further, the processor 202 determines such distributions for the workers belonging to worker category-3 (i.e., the workers located in the US). An example distribution for the workers has been illustrated in FIG. 4B.

At step 308, the plurality of rules indicative of the behavior or the interaction of the requestors, the tasks, and the workers is generated. In an embodiment, the processor 202 is configured to generate the plurality of rules. Further, in an embodiment, the plurality of rules is generated based on the distributions determined for the requestors and the workers. Additionally, the plurality of rules may be generated based on the one or more aspects associated with the crowdsourcing environment. For example, based on the one or more aspects associated with the crowdsourcing environment, the processor 202 may determine that each task has to be sent to more than one worker, to receive a consensus on the response for the task. Thus, the processor 202 may formulate a rule that may allow the allocation of multiple instances of the task to multiple workers. Similarly, the crowdsourcing environment may allow interaction among the one or more workers to complete the task. Thus, the processor 202 may create a rule that allows the interaction between the one or more workers. In an embodiment, the plurality of rules may also be generated based on the categorization of the tasks into the one or more categories. For example, the tasks may be categorized based on the task type and the task remuneration into one or more categories. Accordingly, the processor 202 may determine that the majority of the tasks are of the type “form digitization”. Further, the processor 202 may determine that the task remuneration for the tasks of the type “audio/video transcription” is greater than the task remuneration for the tasks of the type “language translation”, and so on.

In an embodiment, the plurality of rules may comprise a deterministic set of rules and a non-deterministic set of rules. The deterministic set of rules may include to a set of mathematical equations and/or one or more regressive models. The non-deterministic set of rules may include one or more statistical models and/or one or more agent-based models. In an embodiment, the deterministic rules may be generated based on the one or more aspects associated with the requesters, the workers, or the crowdsourcing environment. In an embodiment, the non-deterministic rules may be generated based on the statistical data.

### Deterministic Rules

As discussed above, the deterministic rules may be generated based on the one or more aspects governed by the crowdsourcing environment. For example, the crowdsourcing platform may provide a lower bound for the batch size of the tasks (i.e., minimum batch size) submitted to the crowdsourcing platform by the requestors of various types. For instance, the crowdsourcing platform may require the requestors of the type “Enterprise” or “Government Organization” to submit a minimum of 1000 tasks in each batch of tasks submitted on the crowdsourcing platform. Further, the crowdsourcing platform may require the requestors of the types “University/Academic institution” and “Individual” to submit at least 100 tasks and 25 tasks respectively in each batch of tasks submitted by these requestors on the crowdsourcing platform. To account for such aspects concerning the crowdsourcing platform, the processor 202 may generate the following rules governing the minimum batch size of tasks submitted by the requestors on the crowdsourcing platform:

if (Requestor Type=“Enterprise” or “Government Organization”) {Min.batch size→1000} (1)

if (Requestor Type=“University/Academic institution”) {Min.batch size→100} (2)

if (Requestor Type=“Individual”) {Min.batch size→25} (3)

For example, the type of the crowdsourcing platform (an aspect associated with the crowdsourcing environment that may govern the task performance by the workers) is a crowd-labor platform. In this case, the processor 202 may generate a rule that each task is to be allocated to only one worker at a time, and the workers may not interact with one another for completing the tasks. However, if the type of the crowdsourcing platform is a creative design platform, the processor 202 may generate a rule that multiple workers may work independently on each task such that a change/revision suggested by a first worker is incorporated within the same task presented to a second worker, and so on. Hence, though the workers may work independently on the tasks, the workers may interact indirectly as the changes/revisions suggested by the initial workers (who previously worked on the task) are reflected in the task presented to the subsequent workers. In a similar manner, when the type of the crowdsourcing platform is an open innovation platform, the processor 202 may generate a rule that multiple workers may work simultaneously on each task such that the workers may directly interact with one another while working on the task. Thus, a worker working on a task may collaborate with multiple other workers who are working on the same task.

Further, the deterministic set of rules may be based on the one or more aspects associated with the requestors and the workers, such as the set of static parameters and/or the set of dynamic parameters associated with the requestors and the workers, respectively. For example, the processor 202 may determine a deterministic rule for the evaluation of the tasks based on the expected task accuracy of the tasks. For instance, the processor 202 may determine a deterministic rule that if the expected task accuracy of a task is greater than a predetermined threshold (say 80% or 0.8), the task would require a direct evaluation by the requestor.

Non-Deterministic Rules

As discussed above, the non-deterministic rules may be generated based on the statistical data. For example, based on the statistical data, the processor 202 may determine a distribution for the working hours of the workers located in the US. Accordingly, the processor 202 may determine that a majority of the workers from the US are available between 1 pm-6 pm. Further, the processor 202 may determine a distribution for the accuracy scores of the workers located in the US, based on the statistical data. Based on such distribution, the processor 202 may determine that the workers from the US deliver maximum accuracy between 2 pm-3 pm. Hence, the processor 202 may formulate a rule to transmit the one or more tasks to the workers from the US during the time interval 2 pm-3 pm. Similarly, the processor 202 may formulate other rules.

For example, the processor 202 may determine a relation between the capability of the workers and the service time of the workers based on the distributions determined for the worker capability and the service time of the workers. In an embodiment, the capability of the worker may be deterministic of a number of tasks taken up by the worker per unit time. In an embodiment, the service time of the worker may be deterministic of an average time taken by the worker to complete a task. Based on the distributions for the worker capability and the service time of the workers belonging to a certain category (for instance, the workers belonging to the worker category-1, i.e., the workers located in India), the processor 202 may formulate a rule that an inverse relationship exists between the worker capability and the service time of the workers. Further, based on the statistical data, the processor 202 may determine an empirical equation representative of this inverse relationship between the worker capability and the service time of the workers belonging to each category.

Further, in an embodiment, agent-based modeling may be used to utilize the plurality of rules to simulate the dynamics of crowdsourcing platforms. Using agent-based modeling, each of the one or more entities (i.e., the requestors, the tasks, and the workers) associated with the crowdsourcing platform may be modeled as an independent agent, which may interact with the other agents. The distributions determined for the requestors and the workers may be used in the generation of the agent-based models for the requestors and the workers, respectively. The one or more parameters associated with the tasks may be utilized to generate the agent-based model for the tasks, based on the categorization of the tasks into the one or more categories. In addition, the one or more aspects associated with the crowdsourcing environment may be used to determine the interaction of these entities with each other in the agent based models.

In an embodiment, the processor 202 may associate a weight with each of the one or more parameters associated with the requestors, the tasks, and the workers. In an alternate embodiment, a user may assign the weight to each of the one or more parameters. In an embodiment, the weight associated with the each of the one or more parameters may correspond to degree of relevance assigned to each of the one or more parameters. For example, the weights 0.75 and 0.25 may be assigned to the parameters “location of the workers” and the “age of the workers”, respectively. In this case, the location of the workers may be more relevant than the age of the workers. Further, the weights 0.25, 0.35, 0.25, and 0.15 may be assigned to the parameters “working hours”, “worker capability”, “service time”, and “accuracy score of the workers”, respectively. In this example, the parameters “working hours” and “service time” have a similar relevance; the parameter “accuracy score of the workers” has a lower relevance, while the parameter “worker capability” has a higher relative relevance. Similarly, weights may be assigned to other parameters.

Further, in an embodiment, the weights may correspond to a regression between the one or more parameters and a level of service of the crowdsourcing platform. For example, the level of service in terms of a task accuracy score may be determined as a regressive relationship between the task remuneration and the task type. As the workers may be more motivated if the remuneration for the task is higher in comparison to the task type, the processor 202 may determine the weight for the task remuneration to be higher than the weight for the task type. In an embodiment, such inference is drawn by the processor 202 based on the statistical data. Thus, in this scenario, the weights may correspond to a degree of correlation between the one or more parameters (i.e., the task remuneration and the task type) and the level of service (i.e., the task accuracy score).

A person skilled in the art would understand that the scope of the disclosure should not be limited to the generation of the plurality of rules, as discussed above. The plurality of rules may be generated using any technique known in the art without departing from the spirit of the disclosure. Further, the examples of the plurality of rules are for illustrative purposes and should not be used to limit the scope of the disclosure.

Post generating the plurality of rules, in an embodiment, the processor 202 may estimate the first level of service of the crowdsourcing platform based on the generated rules, as explained further. Further, in an embodiment, the generated plurality of rules may correspond to the crowdsourcing simulator 107.

At step 310, the first level of service of the crowdsourcing platform is estimated based on the generated plurality of rules. In an embodiment, the processor 202 is configured to estimate the first level of service of the crowdsourcing platform based on the generated plurality of rules. As already discussed, in an embodiment, the level of service of the crowdsourcing platform may comprise at least one of a task completion time, a task completion cost, a task accuracy score, a task completion rate, or a number of tasks completed in a period.

For example, the plurality of rules generated in step 308 may include rules associated with the worker capability and the service time of the workers belonging to the worker category-1, i.e., the workers located in India. To determine the completion time per task (i.e., the task completion time) for these workers, the processor 202 may utilize such rules. For instance, the worker category-1 may include 100,000 workers. The processor 202 may determine the rules associated with the worker capability and the service time of such workers based on the statistical data related to these workers. The following table illustrates an example of the statistical data related to the workers of the worker category-1:

TABLE 3
An example of the statistical data related to the workers
belonging to the worker category-1.

| No. of | Worker capability (No. of | Service time |
|---|---|---|
| workers | tasks taken up per hour) | (Time taken per task) |
| 4,500 | 10 | 5 minutes |
| 8,500 | 8 | 7 minutes |
| 12,000 | 6 | 11 minutes |
| 15,000 | 4 | 13 minutes |
| 25,000 | 2 | 16 minutes |
| 35,000 | 1 | 20 minutes |

Referring to Table 3, the average number of tasks taken up per hour by each worker belonging to the worker category-1 may be determined as 3.3 tasks per hour (i.e., (4,500*10+8,500*8+12,000*6+15,000*4+25,000*2+35,000*1)/100,000). Further, the average time taken per task by each worker of the worker category-1 may be determined as 15 minutes per task (i.e., (4,500*5+8,500*7+12,000*11+15,000*13+25,000*16+35,000*20)/100,000). Based on the foregoing, the processor 202 may formulate an empirical rule that the workers belonging to the worker category-1 remain idle for 10.5 minutes per hour (as the workers complete 3.3 tasks @ 15 minutes per task in 49.5 minutes) and the workers spend 50% of this idle time to choose the tasks that they wish to work on. Therefore, the processor 202 may determine the completion time per task as 16.6 minutes (i.e., 15+0.5*(10.5/3.3) minutes, which is 15+1.6 minutes), if 50% of the idle time of the workers (i.e., the time taken by the workers to choose the task) is taken into account while determining the completion time of tasks.

A person skilled in the art would understand that the scope of the disclosure should not be limited to the estimation of the first level of service, as discussed above. The first level of service may be estimated using any other technique without departing from the spirit of the disclosure. Further, the above examples are for illustrative purposes and should not be used to limit the scope of the disclosure.

Post estimating the first level of service, in an embodiment, the processor 202 may send a request to the crowdsourcing platform server 102 for information pertaining to the observed level of service of the crowdsourcing platform. In an embodiment, the processor 202 may determine the observed level of service of the crowdsourcing platform based on the information received from the crowdsourcing platform server 102 in response to the sent request.

At step 312, the plurality of rules is modified based on the first level of service and the observed level of service of the crowdsourcing platform. In an embodiment, the processor 202 is configured to modify the plurality of rules based on the first level of service and the observed level of service. In an embodiment, modified plurality of rules corresponds to the crowdsourcing simulator 107. The modification of the plurality of rules has been described in conjunction with FIG. 5.

FIGS. 4A and 4B illustrate an example distribution for the requestors and the workers (depicted by 402 and 406, respectively), in accordance with at least one embodiment.

Referring to FIG. 4A, an example distribution of the task submission rate of the requestors has been depicted by 402. A person skilled in the art would appreciate that the distribution 402 may pertain to a particular category of the requestors, for instance, the requestors of the requestor-type “Enterprise requestor”, the requestors located in the US, etc. Further, as is evident in FIG. 4A, the distribution 402 may be approximated as an exponential distribution (depicted by 404) using the one or more curve fitting techniques based on the values of the task submission rate of the requestors. A person skilled in the art would appreciate that the distributions of other parameters (within the set of dynamic parameters) associated with the requestors such as, but not limited to, the expected task accuracy and the expected service time may be approximated in a similar manner, using the one or more curve fitting techniques based on the respective values of the other parameters associated with the requestors.

Referring to FIG. 4B, an example distribution of the working hours of the workers has been depicted by 406. A person skilled in the art would appreciate that the distribution 404 may pertain to a particular category of the workers, for instance, the workers located in India, the workers located in the US, etc. Further, as is evident in FIG. 4B, the distribution 404 may be approximated as a normal distribution (depicted by 408) using the one or more curve fitting techniques based on the values of the working hours of the workers. A person skilled in the art would appreciate that the distributions of other parameters (within the set of dynamic parameters) associated with the workers such as, but not limited to, the worker capability, the service time, and the accuracy score may be approximated in a similar manner, using the one or more curve fitting techniques based on the respective values of the other parameters associated with the workers.

FIG. 5 is a flowchart 312 that illustrates a method for modifying the plurality of rules, in accordance with at least one embodiment.

At step 502, the observed level of service of the crowdsourcing platform is determined from the crowdsourcing platform. In an embodiment, the processor 202 is configured to determine the observed level of service from the crowdsourcing platform. In an embodiment, the observed level of service of the crowdsourcing platform may correspond to a particular time-period, which is same as the time-period corresponding to the statistical data. For example, the statistical data corresponds to a historical data related to the requestors, the tasks, and the workers for the previous month. In this case, the observed level of service corresponds to a performance measure of processing the one or more tasks by the crowdsourcing platform during the same previous month.

After the determination of the observed level of service, the processor 202 may compare the first level of service with the observed level of service, as discussed further.

At step 504, the first level of service is compared with the observed level of service of the crowdsourcing platform. In an embodiment, the processor 202 is configured to compare the first level of service with the observed level of service of the crowdsourcing platform. Thereafter, the processor 202 determines whether the first level of service is equal to (or close to) the observed level of service. In an embodiment, the first level of service is determined to be equal to (or close to) the observed level of service if a difference between the first level of service and the observed level of service does not exceed a predetermined threshold, where the predetermined threshold may correspond to a fixed percentage of the observed level of service. For example, if the predetermined threshold is ±2.5% of the observed level of service, the first level of service is determined as equal to the observed level of service when the difference between the first level of service and the observed level of service lies within 2.5% of the value of the observed level of service. If the first level of service and the observed level of service are determined to be unequal, step 506 is performed.

At step 506, one or more characteristics of the distributions determined for the requestors and the workers are varied. In an embodiment, the processor 202 is configured to vary the one or more characteristics of the distributions determined for the requestors and the workers. In an embodiment, the one or more characteristics of the distributions may include, but are not limited to, a mean, a median, a variance, a standard deviation, a marginal statistic, a maxima, a minima, or one or more parameters of the distribution (e.g., alpha and beta parameters, in case the distribution is a beta distribution, and so on). In addition, in an embodiment, the processor 202 may also vary the weights associated with each of the one or more parameters associated with the requestors, the tasks, and the workers.

In an embodiment, the processor 202 may vary the one or more characteristics of the distributions using one or more non-gradient algorithms such as, but not limited to, a genetic algorithm, a particle swarm algorithm, a Tabu search algorithm, a grid search algorithm, a simplex algorithm, a simulated annealing algorithm, a neural network algorithm, or a fuzzy logic algorithm. In an embodiment, the processor 202 may also use the one or more non-gradient algorithms to vary the weights associated with each of the one or more parameters associated with the requestors, the tasks, and the workers.

At step 508, the plurality of rules is modified based on the variation of the one or more characteristics of the determined distributions for the requestors and the workers. In an embodiment, the processor 202 is configured to modify the plurality of rules based on the variation of the one or more characteristics of the distributions. In an embodiment, the processor 202 may modify the plurality of rules based on the variation of the weights associated with each of the one or more parameters associated with the requestors, the tasks, and the workers. Further, in an embodiment, the modification of the plurality of rules may be based on both the variation of the one or more characteristics of the determined distributions, and the variation of the weights associated with each of the one or more parameters.

For example, referring to table 3, the processor 202 determines that the first level of service (in terms of the task completion time) is 16.6 minutes per task. Further, let us consider that the processor 202 determines the observed level of service (in terms of the task completion time) as 18 minutes per task. As discussed, the value of the first level of service is not close to the value of the observed level of service, considering the predetermined threshold as ±2.5%. Therefore, the processor 202 modifies the plurality of rules. To modify the plurality of rules, the processor 202 may vary one or more characteristics (such as mean, variance, etc.) of the distributions. For instance, referring to Table 3, the processor 202 may vary the mean of the distributions of the worker capability (i.e., 3.3 tasks per hour) and the service time of the workers (i.e., 15 minutes per task). Accordingly, the rules generated from such distributions are also modified. For example, the varied values of the means are 3.1 tasks per hour (worker capability) and 15.7 minutes per task (service time of the workers). In this case, the processor 202 may modify the corresponding rule as “The workers belonging to the worker category-1 remain idle for 11.33 minutes per hour (instead of 10.5 minutes per hour, as 3.1 tasks are completed @ 15.7 minutes per task in 48.66 minutes) and the workers spend 50% of this idle time to choose the tasks they wish to work on”.

A person skilled in the art would understand that the scope of the disclosure should not be limited to the modification of the plurality of rules, as discussed above. The plurality of rules may be modified using any other technique without departing from the spirit of the disclosure. Further, the above examples are for illustrative purposes and should not be used to limit the scope of the disclosure. It would also be appreciated that the deterministic set of rules may not be modified as such rules may be governed by the one or more aspects associated with the crowdsourcing environment.

At step 510, the level of service of the crowdsourcing platform is re-estimated based on the modified plurality of rules. In an embodiment, the processor 202 is configured to re-estimate the level of service of the crowdsourcing platform based on the modified plurality of rules. Hereinafter, the re-estimated level of service of the crowdsourcing platform is referred as a second level of service of the crowdsourcing platform. Step 510 is similar to step 310 inasmuch as the plurality of rules used in step 510 is the modified version of the plurality of rules used in step 310.

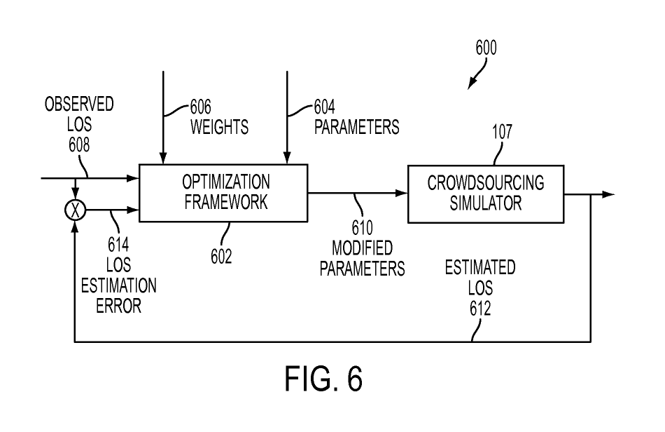

Further, the processor 202 re-iterates the above procedure from step 504. Thus, at step 504, the processor 202 compares the second level of service with the observed level of service, to determine whether the two are equal (or close to each other), as described in step 504. If the second level of service is determined to be unequal (and not close to) the observed level of service, steps 506 through 510 are repeated, and the process may re-iterate several times based on the result of the comparison at step 504 of each iteration. However, if the second level of service is determined to be equal to (or close to) the observed level of service, the process 312 ends, yielding a simulation model tuned to the observed level of service of the crowdsourcing platform. This simulation model may be used to simulate the crowdsourcing platform and as a test bed to design various scheduling algorithms, assist decision making related to the crowdsourcing of tasks to the crowdsourcing platforms, etc. An example scenario of tuning the crowdsourcing simulator 107 with respect to the observed level of service of the crowdsourcing platform has been further explained in conjunction with FIG. 6.

FIG. 6 is a block diagram 600 that illustrates an example scenario of tuning the crowdsourcing simulator 107 with respect to the observed level of service (LOS) of the crowdsourcing platform (e.g., 104a), in accordance with at least one embodiment.

The example scenario (depicted by the block diagram 600) illustrates the tuning of the crowdsourcing simulator 107 with respect to the observed LOS (depicted by 608) of the crowdsourcing platform (i.e., 104a). In an embodiment, the processor 202 is configured to create the crowdsourcing simulator 107 based on the plurality of rules, which in-turn are generated based on the distributions of the set of dynamic parameters (depicted by 604) associated with the requestors and the workers. Thereafter, in an embodiment, the processor 202 is configured to determine an estimated LOS 612 (e.g., the first level of service) based on the plurality of rules associated with the crowdsourcing simulator 107. The determination of the distributions of the parameters 604 has been explained with reference to step 306 (FIG. 3). The generation of the plurality of rules and the creation of the crowdsourcing simulator 107 have been explained with reference to step 308 (FIG. 3). Further, the determination of the estimated LOS 612 (i.e., the first level of service) has been explained with reference to step 310 (FIG. 3).

In an embodiment, the processor 202 may utilize an optimization framework (depicted by 602) to modify the plurality of rules and tune the crowdsourcing simulator 107 with respect to the observed LOS 608. In an embodiment, the optimization framework 602 may correspond to the one or more non-gradient algorithms such as, but not limited to, a genetic algorithm, a particle swarm algorithm, a Tabu search algorithm, a grid search algorithm, a simplex algorithm, a simulated annealing algorithm, a neural network algorithm, or a fuzzy logic algorithm. The modification of the plurality of rules has been explained in conjunction with FIG. 5.

As shown in FIG. 6, the various inputs to the optimization framework include the parameters 604, weights 606, the observed LOS 608, and a feed-back of an LOS estimation error 614 (i.e., the current difference between the estimated LOS 612 (i.e., the first level of service) and the observed LOS 608). In an embodiment, the weights 606 may correspond to a degree of relevance associated with each of the parameters 604 for determining the estimated LOS 612. For example, the parameters 604 include P1, P2, and P3, while the weights 606 include W1, W2, and W3. In this case, the estimated LOS 612 may be determined as a function of P1*W1, P2*W2, and P3*W3. To modify the plurality of rules, in an embodiment, the processor 202 may utilize the optimization framework 602 to adjust the weights 606. In an alternate embodiment, the weights 606 may be specified by a user, and may not be modified as such by the optimization framework 602. Further, in an embodiment, the processor 202 may utilize the optimization framework 602 to vary the one or more characteristics (such as mean, variance, etc) of the distribution of the parameters 604, as explained with reference to step 506 (FIG. 5).

Output of the optimization framework 602 includes modified parameters 610. In an embodiment, the processor 202 may utilize the modified parameters 610 to modify the plurality of rules associated with the crowdsourcing simulator 107. As shown in FIG. 6, the modified parameters 610 are fed into the crowdsourcing simulator 107 for modification of the plurality of rules, as explained with reference to step 508 (FIG. 5). In an embodiment, the processor 202 may modify the plurality of rules associated with the crowdsourcing simulator 107 based on the adjustment of the weights 606, the variation of the one or more characteristics of the distributions (which generates the modified parameters 610), or a combination thereof.

In an embodiment, the processor 202 is configured to determine the estimated LOS 612 (i.e., the second level of service) based on the modified plurality of rules associated with the crowdsourcing simulator 107, as explained with reference to step 510 (FIG. 5). Thereafter, the estimated LOS 612 is compared with the observed LOS 608, as explained with reference to step 504 (FIG. 5). The processor 202 is configured to determine the LOS estimation error 614 as the difference between the estimated LOS 612 and the observed LOS 608. If the LOS estimation error 614 is within the predetermined threshold, the crowdsourcing simulator 107 may estimate the observed level of service and the optimization process ends. However, if the LOS estimation error 614 is not within the predetermined threshold, the optimization framework 602 is fed-back with the LOS estimation error 614 and the processor 202 iterates the optimization process (as described in FIG. 5, steps 506 through 510). As explained, the optimization process continues until the crowdsourcing simulator 107 is tuned to estimate a value of the level of service that is close to the value of the observed level of service 608.

In an embodiment, once the crowdsourcing simulator 107 is tuned with respect to the observed LOS of the crowdsourcing platform, the crowdsourcing simulator 107 may be used to estimate an expected level of service of the crowdsourcing platform (i.e., 104a). For example, the requestor may use the crowdsourcing simulator 107 to get an estimate of an expected completion time of a batch of tasks, which the requestor wishes to submit to the crowdsourcing platform during a particular time of the day. The crowdsourcing simulator 107 may also be used to determine efficiency of various task scheduling algorithms, remuneration schemes, worker training programs, etc.

Though the disclosure is described with respect to creating a simulator for a crowdsourcing platform, a person skilled in the art would understand that the scope of the disclosure is not limited to the simulator for the crowdsourcing platform. In an embodiment, the disclosure may be implemented to create a simulator for various business environments such as, but not limited to, a business process outsourcing platform, a legal process outsourcing platform, a knowledge process outsourcing platform, a home-sourcing platform, or a crowdsourcing platform. Further, the disclosure may be implemented to create a simulator for many different types of crowdsourcing platforms such as, but not limited to, a crowd-labor platform, a crowd-funding platform, a creative-design platform, or an open-innovation platform.

The disclosed embodiments encompass numerous advantages. Various embodiments of the disclosure lead to a generation of an efficient simulation model for simulating a crowdsourcing platform. A bottom-up approach is used for simulating the crowdsourcing platform based on the modeling of the behavior and the interaction of the various entities associated with the crowdsourcing platform, such as the requestors, the tasks, and the workers. This helps in predicting various behavioral aspects of these entities that essentially lies behind the statistical data related to these entities. Such a simulation model may be used to simulate the crowdsourcing platform and as a test bed to design various scheduling algorithms, assist decision making related to the crowdsourcing of tasks to the crowdsourcing platforms, etc. Further, this simulation model may be extendable for simulating various business environments such as a business process outsourcing platform, a legal process outsourcing platform, a knowledge process outsourcing platform, a home-sourcing platform, and various types of crowdsourcing platforms such as a crowd-labor platform, a crowd-funding platform, a creative-design platform, and an open-innovation platform.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for creating a simulator for crowdsourcing platforms have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for creating a simulator for a crowdsourcing platform, the method comprising:
generating, by one or more processors, a plurality of rules indicative of at least one of a behavior or an interaction, of one or more entities associated with the crowdsourcing platform, based on one or more parameters associated with each of the one or more entities;
estimating, by the one or more processors, a first level of service of the crowdsourcing platform based on the generated plurality of rules; and
modifying, by the one or more processors, the plurality of rules based on the first level of service and an observed level of service of the crowdsourcing platform, wherein the observed level of service is determined from the crowdsourcing platform, wherein the modified plurality of rules corresponds to the simulator for the crowdsourcing platform.

2. The method of claim 1, wherein the one or more entities correspond to requestors, tasks, and workers, and wherein a crowdsourcing environment is associated with the crowdsourcing platform.

3. The method of claim 2, wherein the generation of the plurality of rules further comprises categorizing, by the one or more processors, the requestors in one or more categories based on the one or more parameters associated with the requestors, wherein the one or more parameters associated with the requestors comprise at least one of a time zone in which a requestor is located, a type of the requestor, a task submission rate of the requestor, a task accuracy expected by the requestor, a service time expected by the requestor, or a remuneration per task granted by the requestor.

4. The method of claim 2, wherein the generation of the plurality of rules further comprises categorizing, by the one or more processors, the tasks in one or more categories based on the one or more parameters associated with the tasks, wherein the one or more parameters associated with the tasks comprise at least one of a task submission time, a task expiration time, a task type, a task qualification, or a task remuneration.

5. The method of claim 2, wherein the generation of the plurality of rules further comprises categorizing, by the one or more processors, the workers in one or more categories based on the one or more parameters associated with the workers, wherein the one or more parameters associated with the workers comprise at least one of an age of a worker, a gender of the worker, a time zone in which the worker is located, working hours of the worker, a qualification of the worker, an accuracy score of the worker, or an expected remuneration of the worker.

6. The method of claim 2, wherein the crowdsourcing environment associated with the crowdsourcing platform is deterministic of the interaction between the requestors, the tasks, and the workers.

7. The method of claim 2, wherein the generation of the plurality of rules further comprises determining, by the one or more processors, one or more distributions for the requestors and the workers, wherein the one or more distributions are determined using one or more curve fitting techniques based on values of the one or more parameters associated with the requestors and the workers.

8. The method of claim 7, wherein the modification of the plurality of rules further comprises varying, by the one or more processors, one or more characteristics of each of the one or more distributions based on the first level of service and the observed level of service, wherein the one or more characteristics of each of the one or more distributions comprise at least one of a mean, a median, a variance, a standard deviation, a marginal statistic, a maxima, a minima, or one or more parameters of the distribution.

9. The method of claim 8, wherein the one or more characteristics of the distribution are varied such that a second level of service of the crowdsourcing platform, estimated based on the modified plurality of rules, approaches the observed level of service of the crowdsourcing platform.

10. The method of claim 1, wherein the plurality of rules comprises a deterministic set of rules and a non-deterministic set of rules, wherein the deterministic set of rules corresponds to a set of mathematical equations or one or more regressive models, and wherein the non-deterministic set of rules corresponds to one or more statistical models or one or more agent-based models.

11. The method of claim 1, wherein the plurality of rules are modified using one or more non-gradient algorithms comprising at least one of a genetic algorithm, a particle swarm algorithm, a Tabu search algorithm, a grid search algorithm, a simplex algorithm, a simulated annealing algorithm, a neural network algorithm, or a fuzzy logic algorithm.

12. The method of claim 1, wherein a level of service of the crowdsourcing platform comprises at least one of a task completion time, a task completion cost, a task accuracy score, a task completion rate, or a number of tasks completed in a period.

13. A method for creating a simulator for a business environment, the method comprising:
generating, by one or more processors, a plurality of rules indicative of at least one of a behavior or an interaction, of one or more entities associated with the business environment, based on one or more parameters associated with each of the one or more entities;
estimating, by the one or more processors, a first level of service of the business environment based on the generated plurality of rules; and
modifying, by the one or more processors, the plurality of rules based on the first level of service and an observed level of service of the business environment, wherein the observed level of service is determined from the business environment, wherein the modified plurality of rules corresponds to the simulator for the business environment.

14. The system of claim 13, wherein the business environment corresponds to one of a business process outsourcing platform, a legal process outsourcing platform, a knowledge process outsourcing platform, a home-sourcing platform, or a crowdsourcing platform.

15. A system for creating a simulator for a crowdsourcing platform, the system comprising:
one or more processors operable to:
generate a plurality of rules indicative of at least one of a behavior or an interaction, of one or more entities associated with the crowdsourcing platform, based on one or more parameters associated with each of the one or more entities;
estimate a first level of service of the crowdsourcing platform based on the generated plurality of rules; and
modify the plurality of rules based on the first level of service and an observed level of service of the crowdsourcing platform, wherein the observed level of service is determined from the crowdsourcing platform, wherein the modified plurality of rules corresponds to the simulator for the crowdsourcing platform.

16. The system of claim 15, wherein the one or more entities correspond to requestors, tasks, and workers, and wherein a crowdsourcing environment is associated with the crowdsourcing platform.

17. The system of claim 16, wherein to generate of the plurality of rules, the one or more processors are further operable to categorize the requestors in one or more categories based on the one or more parameters associated with the requestors, wherein the one or more parameters associated with the requestors comprise at least one of a time zone in which a requestor is located, a type of the requestor, a task submission rate of the requestor, a task accuracy expected by the requestor, a service time expected by the requestor, or a remuneration per task granted by the requestor.

18. The system of claim 16, wherein to generate of the plurality of rules, the one or more processors are further operable to categorize the tasks in one or more categories based on the one or more parameters associated with the tasks, wherein the one or more parameters associated with the tasks comprise at least one of a task submission time, a task expiration time, a task type, a task qualification, or a task remuneration.

19. The system of claim 16, wherein to generate of the plurality of rules, the one or more processors are further operable to categorize the workers in one or more categories based on the one or more parameters associated with the workers, wherein the one or more parameters associated with the workers comprise at least one of an age of a worker, a gender of the worker, a time zone in which the worker is located, working hours of the worker, a qualification of the worker, an accuracy score of the worker, or an expected remuneration of the worker.

20. The system of claim 15, wherein a level of service of the crowdsourcing platform comprises at least one of a task completion time, a task completion cost, a task accuracy score, a task completion rate, or a number of tasks completed in a period.

21. The system of claim 15, wherein the crowdsourcing platform is one of a crowd-labor platform, a crowd-funding platform, a creative-design platform, or an open-innovation platform.

22. A computer program product for use with a computing device, the computer program product comprising a non-transitory computer readable medium, the non-transitory computer readable medium stores a computer program code for creating a simulator for a crowdsourcing platform, the computer program code is executable by one or more processors in the computing device to:
generate a plurality of rules indicative of at least one of a behavior or an interaction, of one or more entities associated with the crowdsourcing platform, based on one or more parameters associated with each of the one or more entities, wherein the one or more entities correspond to requestors, tasks, and workers, wherein a crowdsourcing environment is associated with the crowdsourcing platform;
estimate a first level of service of the crowdsourcing platform based on the generated plurality of rules, wherein a level of service of the crowdsourcing platform comprises at least one of a task completion time, a task completion cost, a task accuracy score, a task completion rate, or a number of tasks completed in a period; and
modify the plurality of rules based on the first level of service and an observed level of service of the crowdsourcing platform, wherein the observed level of service is determined from the crowdsourcing platform, wherein the plurality of rules are modified such that a second level of service of the crowdsourcing platform, estimated based on the modified plurality of rules, approaches the observed level of service of the crowdsourcing platform, and wherein the modified plurality of rules corresponds to the simulator for the crowdsourcing platform.
